(19) United States
(12) Patent Application Publication
(10) Pub. No.: US 2012/0262448 A1
(43) Pub. Date: Oct. 18, 2012

(54) MOBILE TERMINAL AND CONTROL METHOD THEREOF

(75) Inventors: Jonghwan KIM, Incheon (KR); V. Srinivas C., Bangalore (IN); T. S. Bipin, Bangalore (IN); Krishna R. Mohan, Bangalore (IN); Senthil Raja Gunaseela B., Bangalore (IN)

(73) Assignee: LG Electronics Inc.

(21) Appl. No.: 13/277,965

(22) Filed: Oct. 20, 2011

(30) Foreign Application Priority Data
Apr. 12, 2011 (KR) 10-2011-0033940

(51) Int. Cl. G06F 3/041; G06K 9/00; G06T 15/00

(52) U.S. Cl. 345/419

(57) ABSTRACT

A mobile terminal includes a body configured to have a touch input thereon, a stereoscopic display unit formed at the body, and configured to display a stereoscopic image having different images according to a user's viewing angles, a sensing unit mounted to the body and configured to sense a user's position, and a detecting unit configured to detect, based on the sensed user's position, an image corresponding to a touch input on the stereoscopic image among the different images.

### CROSS-REFERENCE TO RELATED APPLICATION

This application claims priority under 35 U.S.C. §119 to Korean Application No. 10-2011-0033940 filed on Apr. 12, 2011, whose entire disclosure is incorporated herein by reference.

### BACKGROUND OF THE INVENTION

1. Field

This specification relates to a mobile terminal and a control method thereof, and particularly, to a mobile terminal capable of implementing a touch input on a stereoscopic image and a control method thereof.

2. Background

In general, a terminal may be classified into a mobile (portable) terminal and a stationary terminal according to a moveable state. The mobile terminal may be also classified into a handheld terminal and a vehicle mount terminal according to a user's carriage method.

As functions of the terminal become more diversified, the terminal can support more complicated functions such as capturing images or video, reproducing music or video files, playing games, receiving broadcast signals, and the like. By comprehensively and collectively implementing such functions, the mobile terminal may be embodied in the form of a multimedia player or a device.

Various attempts have been made to implement complicated functions in such a multimedia device by means of hardware or software.

The conventional mobile terminal is being evolved to provide more functions to a user and to have a design for enhancing portability. Recently, a mobile terminal capable of implementing a touch input is being spotlighted. As concerns for three-dimensional (3D) images are increased, contents are provided in the form of stereoscopic images on a movie screen or a TV. These stereoscopic images may be implemented in the mobile terminal. Accordingly, may be considered a method for detecting touch inputs with respect to the stereoscopic images more accurately by the mobile terminal.

### SUMMARY OF THE INVENTION

Therefore, an aspect of the detailed description is to provide a mobile terminal capable of more accurately recognizing a touch input on a stereoscopic image, and a control method thereof.

Another aspect of the detailed description is to provide a mobile terminal capable of being operated in a user customized manner through a new mechanism.

To achieve these and other advantages and in accordance with the purpose of this specification, as embodied and broadly described herein, there is provided a mobile terminal including a body configured to have a touch input thereon, a stereoscopic display unit formed at the body and configured to display a stereoscopic image having different images according to a user's viewing angles, a sensing unit mounted to the body and configured to sense a user's position, and a detecting unit configured to detect, based on the sensed user's position, an image corresponding to a touch input on the stereoscopic image among the different images.

According to a first example of the present invention, the sensing unit may include a first sensing portion and a second sensing portion. The first sensing portion may be configured to sense a plurality of user's positions, and the second sensing portion may be configured to sense a motion of an object which performs a touch input on the stereoscopic image.

The detecting unit may set one of the positions as a sensing position based on the motion, and may detect, based on the sensing position, an image corresponding to the sensed touch input among the different images. The sensing position may be a position corresponding to a user who is in a moving direction of the object at a time point when the touch input has been performed.

According to a second example of the present invention, the detecting unit may be configured to detect whether the sensed touch input corresponds to a touch input by a main user among a plurality of users. The sensing unit may include a camera for capturing an image. The detecting unit may be configured to convert a captured image into image data, to determine a preset main user's face based on the image data, and to detect the main user's position based on the determined face.

The sensing unit may include a photo sensor laminated on the stereoscopic display unit so as to capture a user's finger which performs a touch input on the stereoscopic display unit. The detecting unit may be configured to determine the main user's touch input based on at least one of the finger's moving direction and a fingerprint.

According to a third example of the present invention, the sensing unit may include a photo sensor laminated on the stereoscopic display unit so as to capture an image of an object which performs a touch input on the stereoscopic display unit. The user's position may be detected based on a moving direction of the object.

According to a fourth example of the present invention, upon sensing a touch input on the stereoscopic image, the different images may be converted into images corresponding to the sensed touch input, respectively.

According to a fifth example of the present invention, the sensing unit may be configured to sense each of a plurality of user's positions, and the detecting unit may be configured to detect a position of a main user among the plurality of users.

On the stereoscopic display unit, an image corresponding to the main user's position among the different images may be activated, but the rest images may be deactivated. The rest images may be deactivated according to preset conditions. The preset conditions may include at least one of a preset time range and position information of the body.

According to a sixth example of the present invention, the controller provided at the body may be configured to process an image corresponding to a sensed user's position among the different images by a different method from the rest images. As the different method, the corresponding image may be turned on, but the rest images may be turned off. Alternatively, the rest images may be made to emit light more weakly than the corresponding image. Still alternatively, the rest images may be made to have colors different from a color of the corresponding image.

The sensing unit may be configured to trace the sensed user's position, and an image corresponding to the user's position may be real-time updated based on a change of the sensed user's position.

According to a seventh example of the present invention, the sensing unit may be configured to sense each of a plurality of user's positions, and the user's position serving as a detection basis by the detecting unit may correspond to a position of a firstly-sensed user among the plurality of users.

According to an eighth example of the present invention, the stereoscopic display unit may include a display device mounted to the body, a lens array disposed to overlap the display device, and a controller configured to store the stereoscopic image as a plurality of basis images and configured to display the basis images on the display device.

According to another aspect of the present invention, a mobile terminal includes a body configured to have a touch input thereon, a stereoscopic display unit disposed at the body and configured to display different images according to viewing angles in an overlaid manner so as to generate a stereoscopic image, a sensing unit mounted to the body and configured to sense a motion of an object which performs a touch input on the stereoscopic image, and a detecting unit configured to detect, based on the motion of the object, an image corresponding to the touch input by the object among the different images.

The sensing unit may be configured to sense a moving direction of the object, and the detecting unit may be configured to determine a touch input by the object as a touch input on one of the different images based on the moving direction. The sensing unit may include a photo sensor laminated on the stereoscopic display unit so as to capture an image of an object which performs a touch input on the stereoscopic image.

To achieve these and other advantages and in accordance with the purpose of this specification, as embodied and broadly described herein, there is also provided a method for controlling a mobile terminal, the method including displaying a stereoscopic image having different images according to viewing angles, sensing a user's position adjacent to a body, sensing a touch input on the stereoscopic image, and detecting, based on the sensed user's position, an image corresponding to the sensed touch input.

In the step of sensing a user's position, a plurality of user's positions may be detected, respectively. In the step of sensing a touch input, may be detected a position of an object which performs a touch input on the stereoscopic image. In the step of detecting, one of the plurality of users' positions may be set as a user's position corresponding to the sensed touch input based on a position change of the object.

In the step of detecting, may be determined whether the sensed touch input corresponds to a touch input by a main user among the plurality of users.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

FIG. 1 is a block diagram illustrating a mobile terminal according to one embodiment of the present invention;

FIGS. 2A and 2B are conceptual views illustrating an operation example of a mobile terminal according to the present invention;

FIGS. 3A and 3B are front and rear perspective views of the mobile terminal of FIG. 2;

FIG. 4 is an exploded perspective view of the mobile terminal of FIG. 3A;

FIG. 5 is a flowchart illustrating a method for controlling the mobile terminal of FIG. 2;

FIGS. 6A to 6C are conceptual views illustrating one embodiment of a touch input implemented by the control method of FIG. 5;

FIGS. 7A to 7C are conceptual views illustrating another embodiment of a touch input implemented by the control method of FIG. 5;

FIGS. 8A and 8B are conceptual views illustrating a user interface according to another embodiment of the present invention;

FIG. 9 is a conceptual view illustrating a user interface according to still another embodiment of the present invention;

FIG. 10 is an exploded perspective view of a mobile terminal according to another embodiment of the present invention;

FIG. 11 is a conceptual view illustrating one embodiment of a touch input implemented by the mobile terminal of FIG. 10; and

FIGS. 12A to 12C are conceptual views illustrating another embodiment of a touch input implemented by the mobile terminal of FIG. 10.

### DETAILED DESCRIPTION OF THE INVENTION

Description will now be given in detail of the exemplary embodiments, with reference to the accompanying drawings. For the sake of brief description with reference to the drawings, the same or equivalent components will be provided with the same reference numbers, and description thereof will not be repeated.

Hereinafter, a mobile terminal according to the present disclosure will be explained in more detail with reference to the attached drawings. The suffixes attached to components of the wireless speaker, such as ‘module’ and ‘unit or portion’ were used for facilitation of the detailed description of the present disclosure. Therefore, the suffixes do not have different meanings from each other.

The mobile terminal according to the present disclosure may include a portable phone, a smart phone, a laptop computer, a digital broadcasting terminal, Personal Digital Assistants (PDA), Portable Multimedia Player (PMP), a navigation system, etc. However, it will be obvious to those skilled in the art that the present disclosure may be also applicable to a fixed terminal such as a digital TV and a desktop computer.

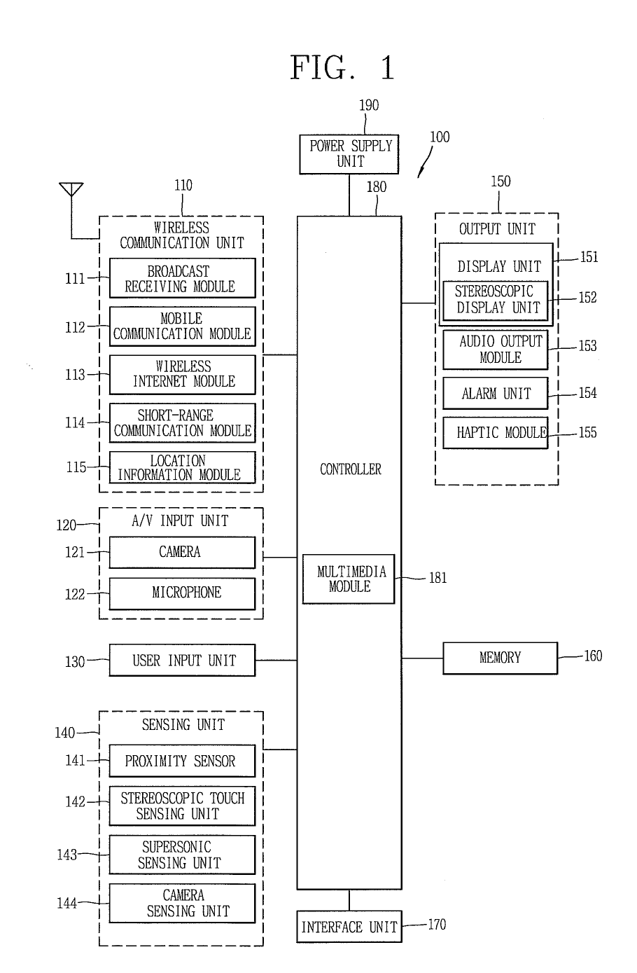

FIG. 1 is a block diagram of a mobile terminal according to one embodiment of the present disclosure.

The mobile terminal 100 may comprise components, such as a wireless communication unit 110, an Audio/Video (A/V) input unit 120, a user input unit 130, a sensing unit 140, an output module 150, a memory 160, an interface unit 170, a controller 180, a power supply unit 190 and the like. FIG. 1 shows the mobile terminal 100 having various components, but it is understood that implementing all of the illustrated components is not a requirement. Greater or fewer components may alternatively be implemented.

Hereinafter, each component is described in sequence.

The wireless communication unit 110 may typically include one or more components which permit wireless communications between the mobile terminal 100 and a wireless communication system or between the mobile terminal 100 and a network within which the mobile terminal 100 is located. For example, the wireless communication unit 110 may include a broadcast receiving module 111, a mobile communication module 112, a wireless internet module 113, a short-range communication module 114, a position information module 115 and the like.

The broadcast receiving module 111 receives a broadcast signal and/or broadcast associated information from an external broadcast managing entity via a broadcast channel. The broadcast associated information may indicate information relating to a broadcasting channel, a broadcasting program or a broadcasting service provider. The broadcast associated information may be provided through a mobile communication network. In this case, the broadcast associated information may be received via the mobile communication module 112. Broadcasting signals and/or broadcasting associated information may be stored in the memory 160.

The mobile communication module 112 transmits/receives wireless signals to/from at least one of network entities (e.g., base station, an external terminal, a server, etc.) on a mobile communication network. Here, the wireless signals may include audio call signal, video call signal, or various formats of data according to transmission/reception of text/multimedia messages.

The wireless internet module 113 supports wireless Internet access for the mobile terminal. This module may be internally or externally coupled to the mobile terminal 100. Examples of such wireless Internet access may include Wireless LAN (WLAN) (Wi-Fi), Wireless Broadband (Wibro), World Interoperability for Microwave Access (Wimax), High Speed Downlink Packet Access (HSDPA), and the like.

The short-range communication module 114 denotes a module for short-range communications. Suitable technologies for implementing this module may include BLUETOOTH, Radio Frequency IDentification (RFID), Infrared Data Association (IrDA), Ultra-WideBand (UWB), ZigBee, and the like.

The position information module 115 denotes a module for sensing or calculating a position of a mobile terminal. An example of the position information module 115 may include a Global Position System (GPS) module.

Referring to FIG. 1, the A/V input unit 120 is configured to provide audio or video signal input to the mobile terminal. The A/V input unit 120 may include a camera 121 and a microphone 122. The camera 121 receives and processes image frames of still pictures or video obtained by image sensors in a video (telephony) call mode or a capturing mode. The processed image frames may be displayed on a display unit 151.

The image frames processed by the camera 121 may be stored in the memory 160 or transmitted to the exterior via the wireless communication unit 110. Two or more cameras 121 may be provided according to the use environment of the mobile terminal.

The microphone 122 may receive an external audio signal while the mobile terminal is in a particular mode, such as a phone call mode, a recording mode, a voice recognition mode, or the like. This audio signal is processed into digital data. The processed digital data is converted for output into a format transmittable to a mobile communication base station via the mobile communication module 112 in case of the phone call mode. The microphone 122 may include assorted noise removing algorithms to remove noise generated in the course of receiving the external audio signal.

The user input unit 130 may generate input data input by a user to control the operation of the mobile terminal. The user input unit 130 may include a keypad, a dome switch, a touchpad (e.g., static pressure/capacitance), a jog wheel, a jog switch and the like. When the touch pad has a layered structure with a display unit 151 to be later explained, this may be referred to as a ‘touch screen’.

The sensing unit 140 provides status measurements of various aspects of the mobile terminal. For instance, the sensing unit 140 may detect an open/close status of the mobile terminal, a change in a location of the mobile terminal 100, a presence or absence of user contact with the mobile terminal 100, the orientation of the mobile terminal 100, acceleration/deceleration of the mobile terminal 100, and the like, so as to generate a sensing signal for controlling the operation of the mobile terminal 100. For example, regarding a slide-type mobile terminal, the sensing unit 140 may sense whether a sliding portion of the mobile terminal is open or closed. Other examples include sensing functions, such as the sensing unit 140 sensing the presence or absence of power provided by the power supply unit 190, the presence or absence of a coupling or other connection between the interface unit 170 and an external device and the like. Moreover, the sensing unit 140 may include a proximity sensor 141, which will be later explained in relation to a touch screen.

The output unit 150 is configured to output an audio signal, a video signal or an alarm signal. The output unit 150 may include a display unit 151, an audio output module 153, an alarm 153, a haptic module 155, and the like.

The display unit 151 may output information processed in the mobile terminal 100. For example, when the mobile terminal is operating in a phone call mode, the display unit 151 will provide a User Interface (UI) or a Graphic User Interface (GUI) which includes information associated with the call. As another example, if the mobile terminal is in a video call mode or a capturing mode, the display unit 151 may additionally or alternatively display images captured and/or received, UI, or GUI.

The display unit 151 may include at least one of a Liquid Crystal Display (LCD), a Thin Film Transistor-Liquid Crystal Display (TFT-LCD), an Organic Light-Emitting Diode (OLED), a flexible display and a three-dimensional (3D) display.

Some of the displays can be configured to be transparent such that it is possible to see the exterior therethrough. These displays may be called transparent displays. A representative example of the transparent display may include a Transparent Organic Light Emitting Diode (TOLED), and the like. The rear surface portion of the display unit 151 may also be implemented to be optically transparent. Under this configuration, a user can view an object positioned at a rear side of a body through a region occupied by the display unit 151 of the body.

The display unit 151 may be implemented in two or more in number according to a configured aspect of the mobile terminal 100. For instance, a plurality of displays may be arranged on one surface integrally or separately, or may be arranged on different surfaces.

Here, if the display unit 151 and a touch sensitive sensor (referred to as a touch sensor) have a layered structure therebetween, the structure may be referred to as a touch screen. The display unit 151 may be used as an input device rather than an output device. The touch sensor may be implemented as a touch film, a touch sheet, a touch pad, and the like.

The touch sensor may be configured to convert changes of a pressure applied to a specific part of the display unit 151, or a capacitance occurring from a specific part of the display unit 151, into electric input signals. Also, the touch sensor may be configured to sense not only a touched position and a touched area, but also a touch pressure.

When touch inputs are sensed by the touch sensors, corresponding signals are transmitted to a touch controller (not shown). The touch controller processes the received signals, and then transmits corresponding data to the controller 180. Accordingly, the controller 180 may sense which region of the display unit 151 has been touched.

Referring to FIG. 1, a proximity sensor 141 may be arranged at an inner region of the mobile terminal covered by the touch screen, or near the touch screen. The proximity sensor 141 indicates a sensor to sense presence or absence of an object approaching to a surface to be sensed, or an object disposed near a surface to be sensed, by using an electromagnetic field or infrared rays without a mechanical contact. The proximity sensor 141 has a longer lifespan and a more enhanced utility than a contact sensor.

The proximity sensor 141 may include a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and so on. When the touch screen is implemented as a capacitance type, proximity of a pointer to the touch screen is sensed by changes of an electromagnetic field. In this case, the touch screen (touch sensor) may be categorized into a proximity sensor.

The display unit 151 may be implemented as a stereoscopic display unit 152 for displaying a stereoscopic image.

Here, the stereoscopic image indicates a three dimensional (3D) stereoscopic image, and the 3D stereoscopic image means an image for implementing depth and sense of reality with respect to an object placed on a monitor or a screen as if in a real space. This 3D stereoscopic image is implemented by using binocular disparity. The binocular disparity indicates parallax due to the difference of positions of two eyes spacing from each other by about 65 mm. Once different 2D images are viewed by two eyes and then are transmitted to a user's brain, the 2D images are synthesized to each other. As a result, the user may feel depth and sense of reality with respect to a stereoscopic image.

A 3D display method such as a stereoscopic method (glasses 3D), an auto-stereoscopic method (glasses-free 3D) and a projection method (holographic 3D) may be applied to the stereoscopic display unit 152. The stereoscopic method mainly applied to a home television receiver, etc. includes a Wheatstone stereoscopic method and so on.

The auto-stereoscopic method mainly applied to a mobile terminal, etc. includes a parallax barrier method, a lenticular method and so on. The projection method includes a reflective holographic method, a transmissive holographic method and so on.

Generally, a 3D stereoscopic image consists of a left image (image for a left eye) and a right image (image for a right eye). According to a method for synthesizing a left image and a right image into a 3D stereoscopic image, 3D technology methods may be categorized into a top-down method for arranging left and right images in one frame in upper and lower directions, a left-to-right (L-to-R) or side by side method for arranging left and right images in one frame in right and left directions, a checker board method for arranging left and right images in the form of tiles, an interlaced method for alternately arranging left and right images as a column unit or as a row unit, a time sequential (frame by frame) method for alternately displaying left and right images according to time, etc.

A 3D thumbnail image may create a left image thumbnail and a right image thumbnail from a left image and a right image of an original image frame. As the created left image thumbnail and a right image thumbnail are integrated, one 3D thumbnail image may be created. Generally, a thumbnail image indicates a contracted image or a contracted still image. These created left and right image thumbnails are displayed on a screen with a distance difference in left and right directions, respectively, by depth corresponding to a time difference of a left image and a right image. This may implement stereoscopic space perception.

A left image and a right image required to implement a 3D stereoscopic image may be displayed on the stereoscopic display unit 152 by a stereoscopic processor (not shown). The stereoscopic processor may be configured to extract right and left images from a received 3D image, or configured to convert a received 2D image into right and left images.

When the stereoscopic display unit 152 and the touch sensor have a layered structure, this may be referred to as ‘stereoscopic touch screen’. When the stereoscopic display unit 152 is combined with a 3D sensor for sensing a touch operation, the stereoscopic display unit 152 may be also used as a 3D input device.

As an example of the 3D sensor, the sensing unit 140 may include a proximity sensor 141, a stereoscopic touch sensing unit 142, a supersonic sensing unit 143 and a camera sensing unit 144.

The proximity sensor 141 measures a distance between an object to be sensed and a detection surface by using strength of an electromagnetic field or infrared rays. Here, the object to be sensed may be a user's finger or a stylus pen. The mobile terminal recognizes a touched part of a stereoscopic image based on the measured distance. When a touch screen is a capacitive type, an approaching degree of the object to be sensed is measured according to a change of an electromagnetic field. Based on this approaching degree, touch in three dimensions may be recognized.

The stereoscopic touch sensing unit 142 is configured to detect intensity (strength) or duration of touch applied onto a touch screen. For instance, the stereoscopic touch sensing unit 142 detects a touch pressure. If the touch pressure is high, the stereoscopic touch sensing unit 142 recognizes the touch as touch on the mobile terminal with respect to an object relatively-farther from a touch screen.

The supersonic sensing unit 143 is configured to recognize position information of an object to be sensed, by using ultrasonic waves.

The supersonic sensing unit 143 may consist of an optical sensor and a plurality of supersonic sensors. The optical sensor is configured to sense light. For instance, the light may be infrared rays, and the optical sensor may be an infrared data association (IRDA).

The supersonic sensor is configured to sense ultrasonic waves. The plurality of supersonic sensors are arranged so as to be spacing from each other. Accordingly, the supersonic sensors have a time difference in sensing ultrasonic waves generated from the same point or neighboring points.

Ultrasonic waves and light are generated from a wave generation source. This wave generation source is provided at an object to be sensed, e.g., a stylus pen. Since light is much faster than ultrasonic waves, time for the light to reach an optical sensor is much shorter than time for the ultrasonic waves to reach supersonic sensors. Accordingly, a position of the wave generation source may be obtained by using a difference of time for the ultrasonic waves to reach with respect to time for the light to reach.

Time for the ultrasonic waves generated from the wave generation source to reach the plurality of supersonic sensors is different from each other. Once a stylus pen moves, the time difference is changed. Accordingly, position information may be calculated according to a moving path of the stylus pen. However, the supersonic sensing unit is not limited to a method for emitting ultrasonic waves from the stylus pen. For instance, the supersonic sensing unit may be applied to a method for generating ultrasonic waves from the mobile terminal, and sensing ultrasonic waves reflected from an object to be sensed.

The camera sensing unit 144 includes at least one of a camera, a photo sensor and a laser sensor.

As one example, the camera and the laser sensor are combined with each other, thereby sensing touch of an object to be sensed with respect to a 3D stereoscopic image. By adding distance information detected by the laser sensor to a 2D image captured by the camera, 3D information may be obtained.

As another example, the photo sensor may be laminated on a display device. The photo sensor is configured to scan a movement of an object to be sensed, the object adjacent to the touch screen. More concretely, the photo sensor is mounted with a photo diode and a transistor (TR) in directions of rows and columns, and scans an object placed thereon based on an electrical signal changed according to the amount of light applied to the photo diode. That is, the photo sensor calculates a coordinate value of an object to be sensed according to a change amount of light, thereby acquiring position information of the object to be sensed.

The audio output module 153 may convert and output as sound audio data received from the wireless communication unit 110 or stored in the memory 160 in a call signal reception mode, a call mode, a record mode, a voice recognition mode, a broadcast reception mode, and the like. Also, the audio output module 153 may provide audible outputs related to a particular function performed by the mobile terminal 100 (e.g., a call signal reception sound, a message reception sound, etc.). The audio output module 153 may include a speaker, a buzzer, and so on.

The alarm unit 154 (or other type of user notification devices) may provide outputs to inform about the occurrence of an event of the mobile terminal 100. Typical events may include call reception, message reception, key signal inputs, a touch input, etc. In addition to audio or video outputs, the alarm unit 154 may provide outputs in a different manner to inform about the occurrence of an event. The video signal or the audio signal may be output via the display unit 151 or the audio output module 153. Accordingly, the display unit 151 or the audio output module 153 may be classified as a part of the alarm unit 154.

The haptic module 155 generates various tactile effects which a user can feel. A representative example of the tactile effects generated by the haptic module 155 includes vibration. Vibration generated by the haptic module 155 may have a controllable intensity, a controllable pattern, and so on. For instance, different vibration may be output in a synthesized manner or in a sequential manner.

The haptic module 155 may generate various tactile effects, including not only vibration, but also arrangement of pins vertically moving with respect to a skin being touched (contacted), air injection force or air suction force through an injection hole or a suction hole, touch by a skin surface, presence or absence of contact with an electrode, effects by stimulus such as an electrostatic force, reproduction of cold or hot feeling using a heat absorbing device or a heat emitting device, and the like.

The haptic module 155 may be configured to transmit tactile effects (signals) through a user's direct contact, or a user's muscular sense using a finger or a hand. The haptic module 155 may be implemented in two or more in number according to the configuration of the mobile terminal 100.

The memory 160 may store a program for the processing and control of the controller 180. Alternatively, the memory 160 may temporarily store input/output data (e.g., phonebook data, messages, still images, video and the like). Also, the memory 160 may store data relating to various patterns of vibrations and audio output upon the touch input on the touch screen.

The memory 160 may be implemented using any type of suitable storage medium including a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like. Also, the mobile terminal 100 may operate a web storage which performs the storage function of the memory 160 on the Internet.

The interface unit 170 may generally be implemented to interface the mobile terminal with external devices. The interface unit 170 may allow a data reception from an external device, a power delivery to each component in the mobile terminal 100, or a data transmission from the mobile terminal 100 to an external device. The interface unit 170 may include, for example, wired/wireless headset ports, external charger ports, wired/wireless data ports, memory card ports, ports for coupling devices having an identification module, audio Input/Output (I/O) ports, video I/O ports, earphone ports, and the like.

The identification module may be configured as a chip for storing various information required to authenticate an authority to use the mobile terminal 100, which may include a User Identity Module (UIM), a Subscriber Identity Module (SIM), a Universal Subscriber Identity Module (USIM), and the like. Also, the device having the identification module (hereinafter, referred to as ‘identification device’) may be implemented in a type of smart card. Hence, the identification device can be coupled to the mobile terminal 100 via a port.

Also, the interface unit 170 may serve as a path for power to be supplied from an external cradle to the mobile terminal 100 when the mobile terminal 100 is connected to the external cradle or as a path for transferring various command signals inputted from the cradle by a user to the mobile terminal 100. Such various command signals or power inputted from the cradle may operate as signals for recognizing that the mobile terminal 100 has accurately been mounted to the cradle.

The controller 180 typically controls the overall operations of the mobile terminal 100. For example, the controller 180 performs the control and processing associated with telephony calls, data communications, video calls, and the like. The controller 180 may include a multimedia module 181 which provides multimedia playback. The multimedia module 181 may be configured as part of the controller 180 or as a separate component.

The controller 180 can perform a pattern recognition processing so as to recognize writing or drawing input on the touch screen as text or image.

The power supply unit 190 serves to supply power to each component by receiving external power or internal power under control of the controller 180.

Various embodiments described herein may be implemented in a computer-readable medium using, for example, software, hardware, or some combination thereof.

For a hardware implementation, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, micro processors, other electronic units designed to perform the functions described herein, or a selective combination thereof. In some cases, such embodiments are implemented by the controller 180.

For software implementation, the embodiments such as procedures and functions may be implemented together with separate software modules each of which performs at least one of functions and operations. The software codes can be implemented with a software application written in any suitable programming language. Also, the software codes may be stored in the memory 160 and executed by the controller 180.

The user input unit 130 is manipulated to receive a command for controlling the operation of the mobile terminal 100, and may include a plurality of manipulation units. The manipulation units may be referred to as manipulating portions, and may include any type of ones that can be manipulated in a user's tactile manner.

Various types of visible information may be displayed on the display unit 151. Such information may be displayed in several forms, such as character, number, symbol, graphic, icon or the like. Alternatively, such information may be implemented as a 3D stereoscopic image.

For input of the information, at least one of characters, numbers, graphics or icons may be arranged and displayed in a preset configuration, thus being implemented in the form of a keypad. Such keypad may be called ‘soft key.’

The display unit 151 may be operated as a single entire region or by being divided into a plurality of regions. For the latter, the plurality of regions may cooperate with one another.

For example, an output window and an input window may be displayed at upper and lower portions of the display unit 151, respectively. Soft keys representing numbers for inputting telephone numbers or the like may be output on the input window. When a soft key is touched, a number or the like corresponding to the touched soft key is output on the output window. Upon manipulating the manipulation unit, a call connection for a telephone number displayed on the output window is attempted, or a text output on the output window may be input to an application.

In addition to the input manner illustrated in the embodiments, the display unit 151 or the touch pad may be scrolled to receive a touch input. A user may scroll the display unit 151 or the touch pad to move a cursor or pointer positioned on an object (subject), e.g., an icon or the like, displayed on the display unit 151. In addition, in case of moving a finger on the display unit 151 or the touch pad, the path of the finger being moved may be visibly displayed on the display unit 151, which can be useful upon editing an image displayed on the display unit 151.

One function of the mobile terminal may be executed in correspondence with a case where the display unit 151 (touch screen) and the touch pad are touched together within a preset time. An example of being touched together may include clamping a body with the user's thumb and index fingers. The one function, for example, may be activating or deactivating of the display unit 151 or the touch pad.

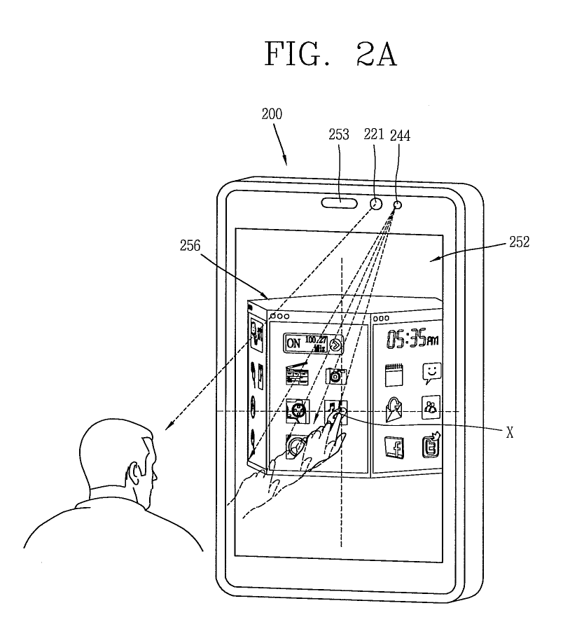

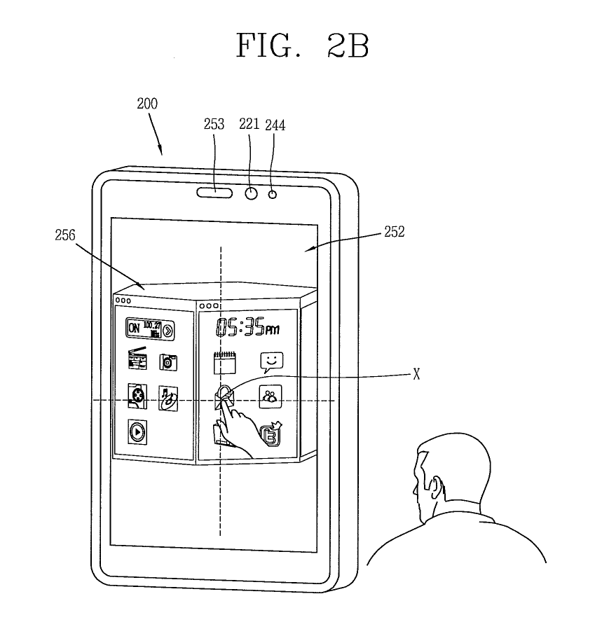

Hereinafter, a mechanism for more precisely recognizing a touch input on a stereoscopic image will be explained in more details. FIGS. 2A and 2B are conceptual views illustrating an operation example of a mobile terminal according to the present invention.

Referring to FIG. 2, a mobile terminal 200 is provided with a stereoscopic display unit 252 disposed on one surface, e.g., a front surface thereof. The stereoscopic display unit 252 is configured to have a touch input thereon. On the stereoscopic display unit 252, displayed a stereoscopic image 256 having different images according to a user's viewing angles. The stereoscopic image 256 may be implemented in the form of images, texts, icons, etc.

Even if a user touches the same point on the stereoscopic display unit 252, an image to be touched becomes different according to the user's position. More concretely, the stereoscopic image 256 has different images according to a user's position. The mobile terminal detects, among the different images, an image corresponding to a user's touch input. Then, the mobile terminal executes a corresponding control command.

For instance, once a user touches an icon (music play icon) on a specific point (‘X’) at the left side, a control command corresponding to the icon is executed (refer to FIG. 2A). If the user touches an icon disposed on the same position on the stereoscopic display unit 252 at the right side, a different icon (mail sending icon) is displayed. In this case, even if the user has touched the same point (‘X’) on the stereoscopic display unit 252, a control command corresponding to the different icon is executed.

Under this configuration, a user's selection for a stereoscopic image may be recognized more precisely.

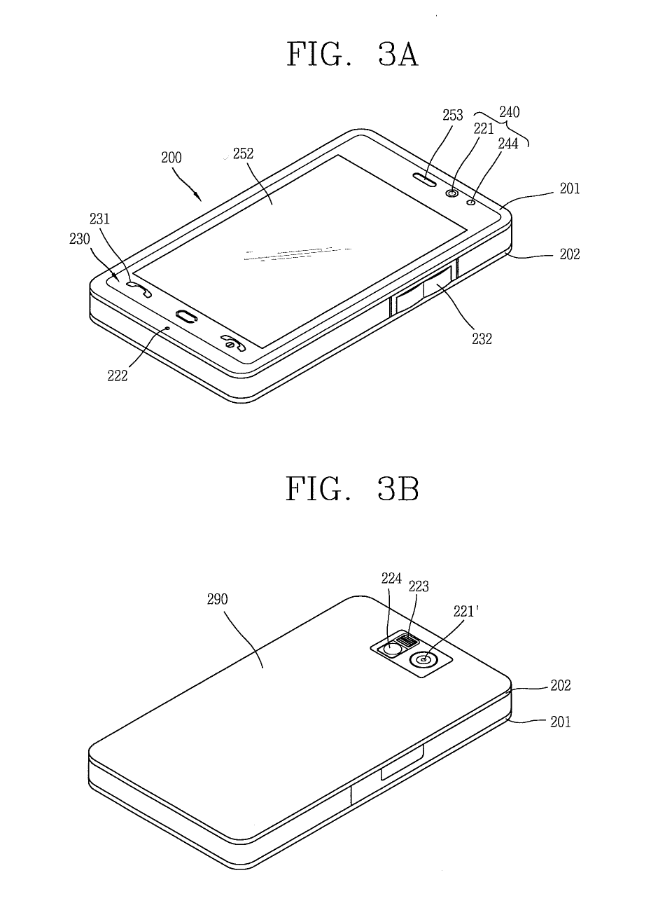

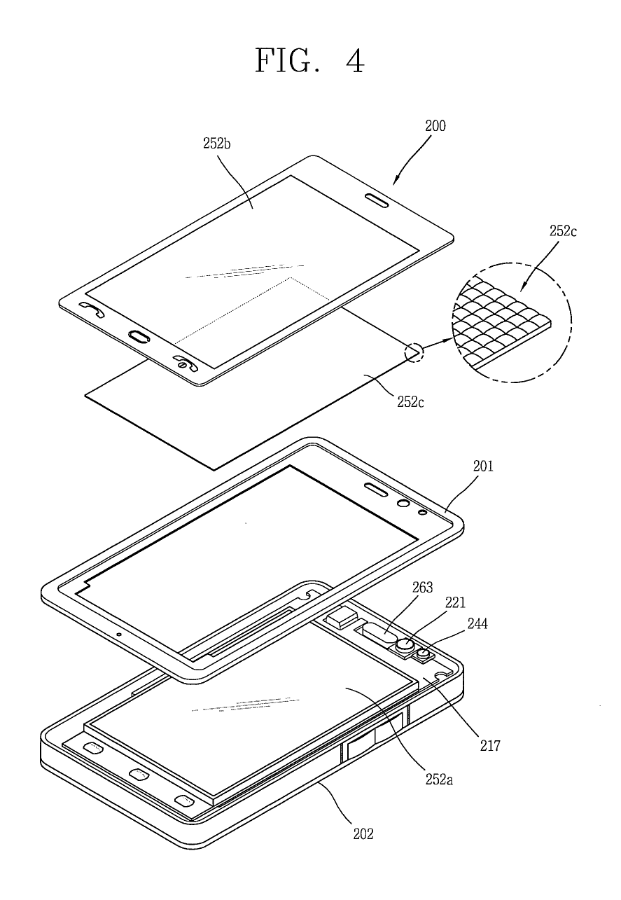

Hereinafter, a hardware configuration of the mobile terminal which can execute the operations of FIG. 2 will be explained in more details with reference to FIGS. 3A, 3B and 4. FIG. 3A is a front perspective view of the mobile terminal according to the present invention, and FIG. 3B is a rear perspective view of the mobile terminal of FIG. 3A.

As shown in FIGS. 2A and 2B, the mobile terminal 200 is a bar type mobile terminal. However, the present disclosure is not limited to this, but may be applied to a slide type in which two or more bodies are coupled to each other so as to perform a relative motion, a folder type, or a swing type, a swivel type and the like.

A case (casing, housing, cover, etc.) forming an outer appearance of a body may include a front case 201 and a rear case 202. A space formed by the front case 201 and the rear case 202 may accommodate various components therein. At least one intermediate case may further be disposed between the front case 201 and the rear case 202.

Such cases may be formed by injection-molded synthetic resin, or may be formed using a metallic material such as stainless steel (STS) or titanium (Ti).

At the front case 201, may be disposed a stereoscopic display unit 252, a sensing unit 240, an audio output unit 253, a camera 221, user input units 230/231 and 232, a microphone 222, an interface unit 270, etc.

The stereoscopic display unit 252 occupies most parts of a main surface of the front case 201. The audio output unit 253 and the camera 221 are arranged at a region adjacent to one end of the stereoscopic display unit 252, and the user input unit 231 and the microphone 222 are arranged at a region adjacent to another end of the stereoscopic display unit 252. The user input unit 232, the interface unit 270, etc. may be arranged on side surfaces of the front case 201 and the rear case 202.

The user input unit 230 is manipulated to receive a command for controlling the operation of the mobile terminal 200, and may include a plurality of manipulation units 231 and 232. The manipulation units may be referred to as manipulating portions, and may include any type of ones that can be manipulated in a user's tactile manner.

Commands inputted through the first or second user input units 231 and 232 may be variously set. For instance, the first manipulation 231 is configured to input commands such as START, END, SCROLL or the like, and the second manipulation unit 232 is configured to input commands for controlling a level of sound outputted from the audio output unit 253, or commands for converting the current mode of the stereoscopic display unit 252 to a touch recognition mode.

The stereoscopic display unit 252 implements a stereoscopic touch screen together with the sensing unit 240, and the stereoscopic touch screen may be an example of the user input unit 230.

The sensing unit 240 is configured to sense a user's position. Furthermore, the sensing unit 240 serving as a 3D sensor is configured to sense a 3D position of an object to be sensed, the object which performs a touch input (e.g., user's finger or stylus pen). The sensing unit 240 may consist of a camera 221 and a laser sensor 244. The laser sensor 244 is mounted to the terminal body, and is configured to irradiate a laser and to sense a reflected laser. Under this configuration, the laser sensor 244 may sense a distance between the terminal body and an object to be sensed. The camera 221 is configured to capture 2D positions of a user and an object to be sensed (refer to FIG. 2A).

For instance, the mobile terminal may sense a user's 2D position based on an image captured through the camera 221, thereby recognizing an image being currently viewed by the user. Furthermore, the mobile terminal may sense a 3D position of an object to be sensed, by combining an object's 2D position captured by the camera 221 with a spacing distance acquired by the laser sensor 244. If a user's 2D image is required (refer to FIG. 2), the sensing unit 240 may consist of only the camera 221. However, the present invention is not limited to this. That is, the sensing unit 240 may consist of a proximity sensor, a stereoscopic touch sensing unit, a supersonic sensing unit, etc.

Referring to FIG. 3B, a camera 221′ may be additionally provided on the rear case 202. The camera 221′ faces a direction which is opposite to a direction faced by the camera 221 (refer to FIG. 2A), and may have different pixels from those of the camera 221.

For example, the camera 221 may operate with relatively lower pixels (lower resolution). Thus, the camera 221 may be useful when a user can capture his face and send it to another party during a video call or the like. On the other hand, the camera 221′ may operate with a relatively higher pixels (higher resolution) such that it can be useful for a user to obtain higher quality pictures for later use. The cameras 221 and 221′ may be installed at the body so as to rotate or pop-up.

A flash 223 and a mirror 224 may be additionally disposed adjacent to the camera 221′. The flash 223 operates in conjunction with the camera 221′ when taking a picture using the camera 221′. The mirror 224 can cooperate with the camera 221′ to allow a user to photograph himself in a self-portrait mode.

An audio output unit may be additionally arranged on a rear surface of the body. The audio output unit may cooperate with the audio output unit 253 (refer to FIG. 3A) disposed on a front surface of the body so as to implement a stereo function. Also, the audio output unit may be configured to operate as a speakerphone.

A power supply unit 290 for supplying power to the mobile terminal 200 is mounted to the terminal body. The power supply unit 290 may be mounted in the terminal body, or may be detachably mounted to the terminal body.

At the terminal body, may be arranged not only an antenna for calling, but also an antenna for receiving a broadcasting signal, a Bluetooth antenna, an antenna for receiving a satellite signal, an antenna for receiving wireless Internet data, etc.

A mechanism for implementing the mobile terminal shown in FIG. 2 is mounted in the body. Hereinafter, the mechanism will be explained in more details with reference to FIG. 4. FIG. 4 is an exploded perspective view of the mobile terminal of FIG. 3A.

Referring to FIG. 4, a window 252b is coupled to one surface of a front case 201. The window 252b is formed of a transmissive material, e.g., a transmissive synthetic resin, a reinforced glass, etc. However, the window 252b may include a non-transmissive region. As shown, the non-transmissive region may be implemented as a pattern film covers the window 252b. The pattern film may be implemented to have a transparent center portion and an opaque edge portion.

A display (or display device 252a) may be mounted to a rear surface of the window 252b. A transmissive region of the window 252b may have an area corresponding to the display 252a. This may allow a user to recognize, from the outside, visual information output from the display 252a.

A circuit board 217 may be mounted to the rear case 202. The circuit board 217 may be implemented as an example of the controller 180 (refer to FIG. 1) for operating each kind of functions of the mobile terminal. As shown, a sound output device 263, a camera 221, etc. may be mounted to the circuit board 217. The sound output device 263 may be implemented as a speaker, a receiver, etc., and the camera 221 may be implemented as an example of the sensing unit 240 configured to sense a user's position.

A laser sensor 244 configured to sense a three-dimensional (3D) position of an object may be mounted to the circuit board 217. The mobile terminal may recognize a touch input on a stereoscopic image through the detection of the 3D position.

Alternatively, a touch sensor (not shown) configured to detect a touch input may be mounted to the window 252b. When a stereoscopic image is formed toward the inside of the mobile terminal from the window 252b (minus depth), a touch on the stereoscopic image may be detected through the touch sensor. In this case, the mobile terminal may not be provided with the laser sensor 244.

A lens array 252c is arranged on the display 252a of the mobile terminal in an overlaid manner. The lens array 252c may be formed to have a fly's eye shape. More concretely, the lens array 252c is disposed between the display 252a and the window 252b, and a processor of the circuit board 217 displays basis images on the display 252a for implementation of a stereoscopic image. The basis images may be a plurality of basis images occurring from a stereoscopic image captured through the same lens as the lens array 252c. This configuration may implement a natural stereoscopic image having different images according to viewing angles, and providing less eye fatigue.

The window 252b, the display 252a and the lens array 252c constitute the stereoscopic display unit 252. This stereoscopic display unit 252 displays a stereoscopic image having different images according to viewing angles.

In this case, it is difficult to detect, among the different images, an image corresponding to a touch input on the same point. In order to solve this, the mobile terminal is configured to detect, among the different images, an image corresponding to a touch input on the stereoscopic image. The detection may be performed by a detecting unit (not shown) implemented by an integral device mounted to the circuit board. Hereinafter, a control method to which the detection has been applied will be explained in more details.

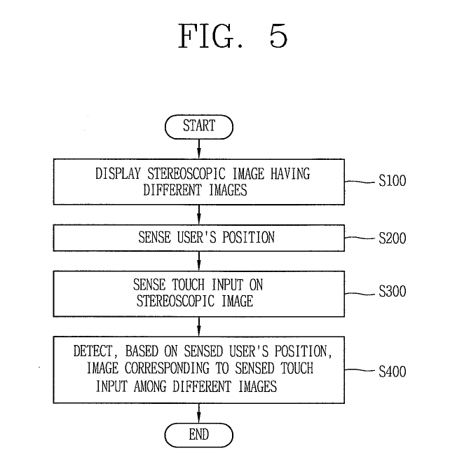

FIG. 5 is a flowchart illustrating a method for controlling the mobile terminal of FIG. 2.

Referring to FIG. 5, the mobile terminal displays a stereoscopic image having different images according to a user's viewing angles (S100). The stereoscopic image may be implemented by an integral imaging method, and may be outwardly or inwardly protruding from the window of the mobile terminal.

Then, the sensing unit senses a user's position adjacent to the body (S200). The sensing unit is configured to sense a user's two-dimensional position (e.g., a position on a plane parallel to the window of the mobile terminal), or a user's three-dimensional position (a position including a vertical distance from the window).

Finally, the sensing unit senses a touch input on a stereoscopic image (S300), and detects, based on the sensed user's position, an image corresponding to the sensed touch input among the different images (S400).

The touch input may be sensed by using at least one of a touch sensing on the touch screen, a pressure sensing for sensing a pressure applied onto the touch screen, a proximity degree sensing with respect to the touch screen, a 3D position sensing with respect to an object using a supersonic wave, and a 3D position sensing using a camera.

In S200, a plurality of users' positions are sensed, respectively. In S300, sensed is a position of an object which performs a touch input on the stereoscopic image. In S400, one of the plurality of users' positions is set as a user's position corresponding to the sensed touch input based on a position change of the object.

For instance, a plurality of users' 2D positions are sensed through a camera, and a position and a moving direction of an object are sensed by using a 3D sensing technique or through a scanning using a photo sensor. Then, the detected positions are combined with each other to set a user's position corresponding to the sensed touch input. In conclusion, an image corresponding to the user's position is regarded as an image to be touch-input.

When a plurality of users perform touch inputs on the mobile terminal with viewing different images, the touch inputs may be recognized more precisely.

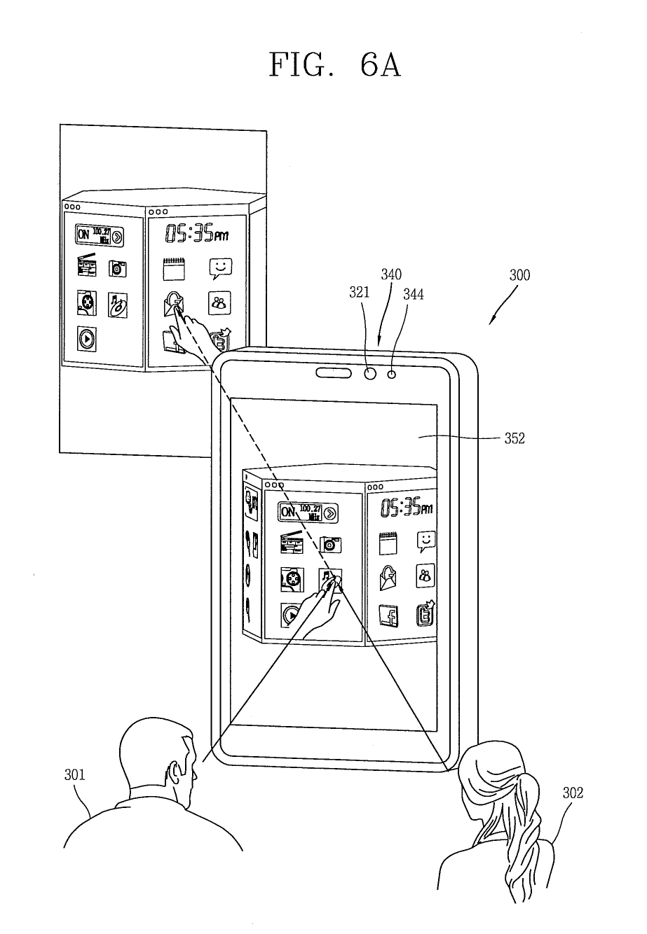

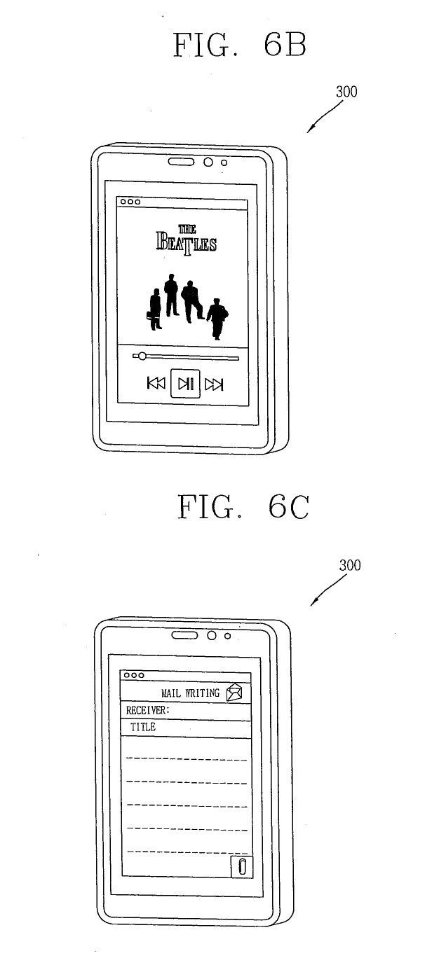

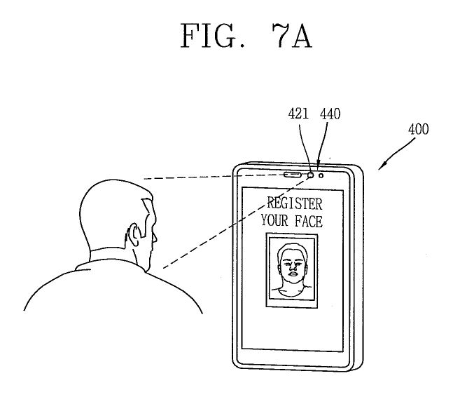

Hereinafter, a plurality of operation examples which may be implemented by the control method will be explained in more details. FIGS. 6A to 6C are conceptual views illustrating one embodiment of a touch input implemented by the control method of FIG. 5.

FIGS. 6A to 6C illustrate a case where a plurality of users use a mobile terminal unlike the case where one user uses a mobile terminal (refer to FIG. 2A).

Once a first user 301 touches one icon (music play icon) disposed on one surface of a hexahedron at the left side as shown in FIG. 6A, a control command (music play) corresponding to the icon is executed as shown in FIG. 6B. On the contrary, once a second user 302 touches another icon (mail sending icon) disposed on another surface of the hexahedron at the right side as shown in FIG. 6A, a control command (mail sending mode execution) corresponding to said another icon is executed as shown in FIG. 6C. Here, said another icon is an icon which is out of the range of the first user's viewing angle. In this preferred embodiment, a plurality of users perform touch inputs with respect to different images with viewing different images.

The preferred embodiment may be implemented by a sensing unit 340 and a detecting unit. The sensing unit 340 is configured to detect a plurality of users' positions, respectively. Referring to FIG. 6A, the sensing unit 340 includes a first sensing portion 321 and a second sensing portion 344.

The first sensing portion 321 is configured to detect a plurality of users' positions, respectively. Referring to FIG. 6A, the first sensing portion 321 is implemented as a camera. However, the present invention is not limited to this. For instance, the first sensing portion 321 may be a 3D sensor.

The second sensing portion 344 is configured to sense a motion of an object which performs a touch input on a stereoscopic image. The second sensing portion 344 may be implemented as a laser sensor, a supersonic sensor, a stereo camera, a radar, etc. The motion of the object may be detected through combinations between the first and second sensing portions 321 and 344. For instance, a 3D motion of the object may be detected through combinations between a camera and a laser sensor.

The detecting unit sets one of the plurality of users' positions as a sensing position based on the motion, and detects, based on the sensing position, an image corresponding to the sensed touch input among the different images. The sensing position may be a position corresponding to a user who is in a moving direction of the object at a time point when the touch input has been performed.

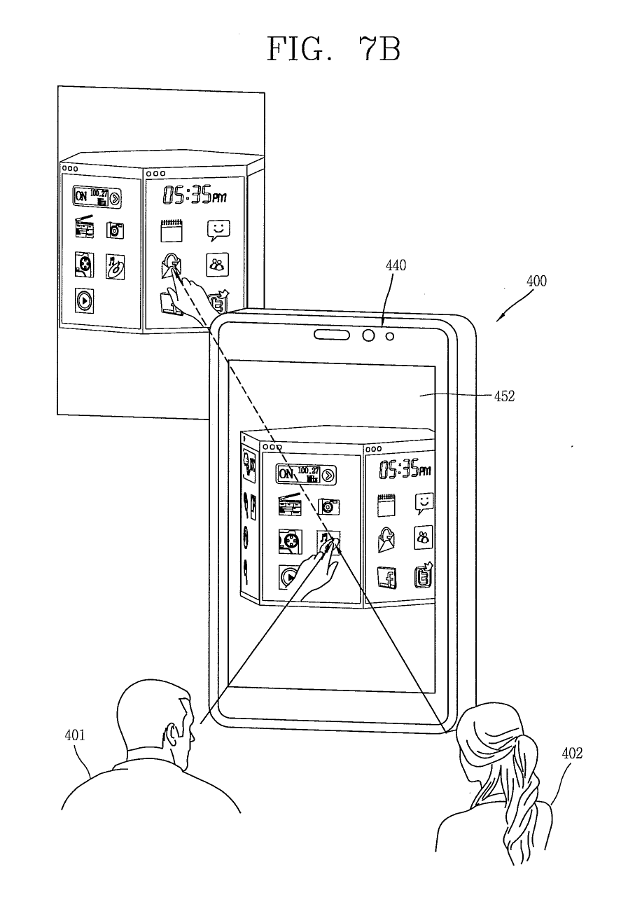

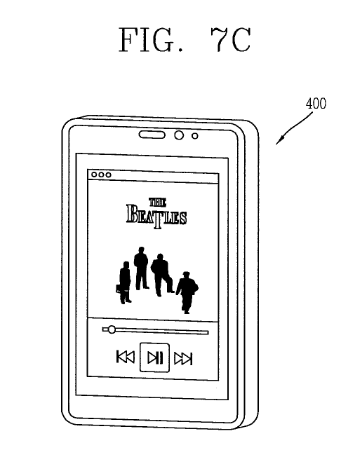

FIGS. 7A to 7C are conceptual views illustrating another embodiment of a touch input implemented by the control method of FIG. 5.

In a case that a plurality of users simultaneously view a stereoscopic image, only a touch input by a main user is executed but touch inputs by other users are not executed.

The mobile terminal is configured to detect whether a sensed touch input corresponds to a touch input by a main user among a plurality of users. More concretely, the detecting unit detects a position of a main user among a plurality of users. For this, the sensing unit 440 includes a camera for capturing an image. And, the detecting unit is configured to convert a captured image into image data, to determine a preset main user's face based on the image data, and to detect the main user's position based on the determined face.

The main user's face may be recognized by a face recognition algorithm.

As one example of the face recognition algorithm, the image data is compared with reference data stored as a database. Then, data matching the reference data as a result of the comparison is detected from the image data. Then, the data matching the reference data is recognized as a user's face. Here, the reference data may be data preset in correspondence to a user's face.

As another example of the face recognition algorithm, the data matching the reference data is recognized as a part (eyes, nose, mouth, etc.) of a user's face. Here, the reference data may be data preset in correspondence to a part of a user's face. For instance, reference data with respect to a nose is stored in the form of database, and then is compared with the image data. If there is matching data as a result of the comparison, sub data positioned within a preset range based on the matching data is recognized as a user's face. The preset range indicates upper, lower, right and left sides based on a nose, which may be a data range corresponding to a face size. This may allow data processing amount for face enlargement to be reduced.

More concretely, referring to FIG. 7A, the mobile terminal is configured to receive a registration of a main user's face through a camera 421. Even if touch inputs are executed by a plurality of users as shown in FIG. 7B, only a touch input by a main user is executed as shown in FIG. 7C.

The sensing unit 440 may be configured to sense not only a user's position but also a motion of an object. In this case, the mobile terminal compares a moving direction of the object with the main user's position. If it is determined that the object is approaching to the mobile terminal from the main user's position, the mobile terminal executes a control command corresponding to a touch input.

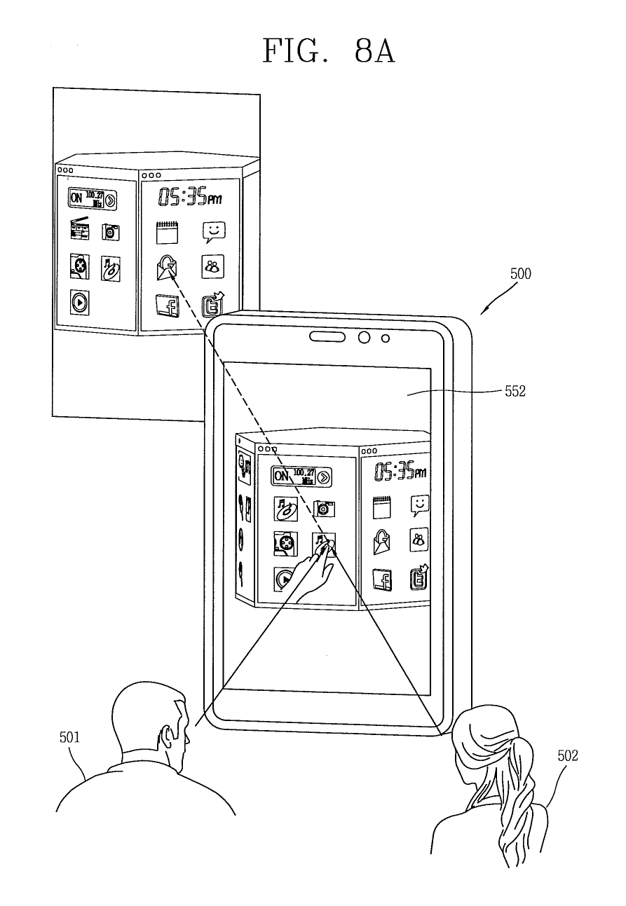

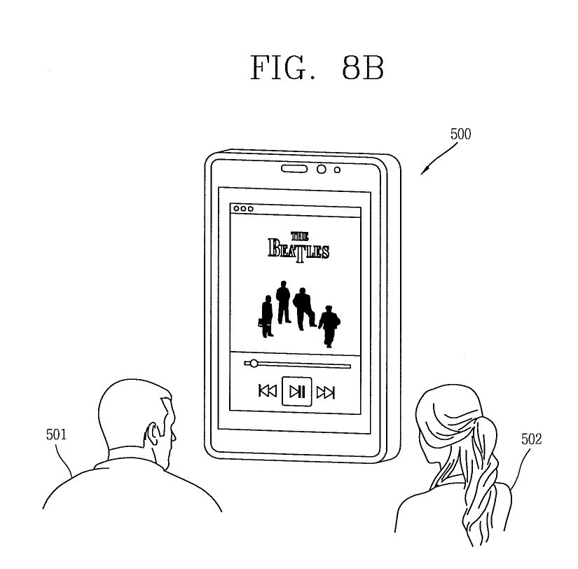

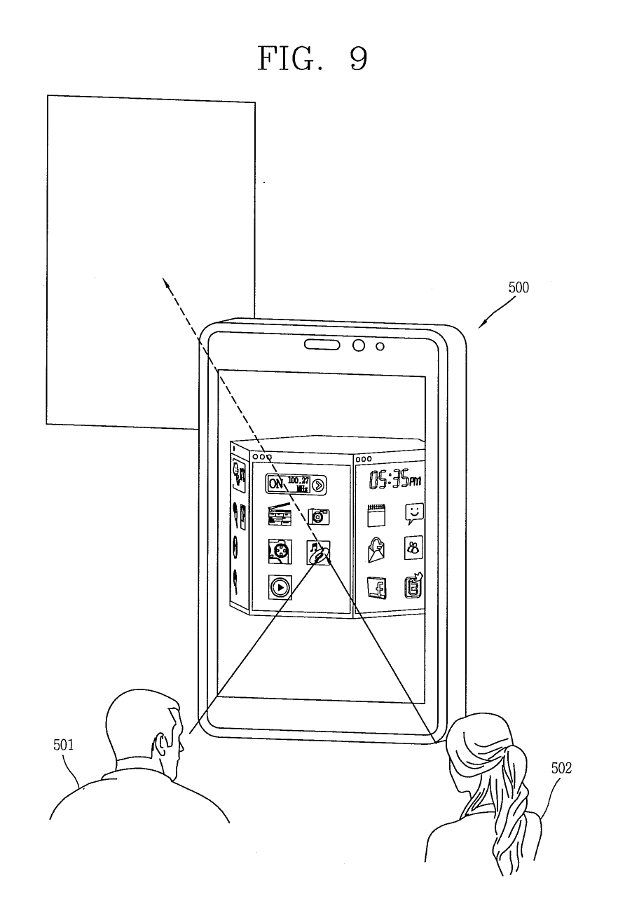

FIGS. 8A, 8B and 9 are conceptual views illustrating a user interface according to another embodiment of the present invention.

Referring to FIGS. 8A and 8B, upon sensing a touch input on a stereoscopic image, different images which constitute the stereoscopic image are converted into images corresponding to the sensed touch input, respectively.

More concretely, if a plurality of users 501 and 502 perform a touch input while viewing different images at different positions (refer to FIG. 8a), the controller converts the respective images into an execution screen corresponding to the touch input (refer to FIG. 8b). For instance, as basis images displayed on the display 252a (refer to FIG. 4) are converted into the same image corresponding to a touch input, a user interface applied to an integral imaging method may be implemented.

Referring to FIG. 9, on a stereoscopic display unit 252, an image corresponding to a position of the main user 501 among different images of a stereoscopic image is activated, but other images are deactivated. For instance, upon sensing a position of the main user by the detecting unit, the controller activates only an image corresponding to the main user's position. On the other hand, the controller deactivates the rest images to protect the main user's privacy.

The rest images may be deactivated by preset conditions. In this case, the preset conditions may include at least one of a preset time range and position information of the body.

For instance, when a preset time is night, using the mobile terminal by a child at night is restricted. Alternatively, when a preset time is daytime, using the mobile terminal by a third party during a work time is restricted.

Position information of the body may be acquired by a GPS, etc. If the position information of the body is set as home, all images are activated at home. This may allow the images to be shared by family members, or allow only a main user to view the images at a place rather than the home (blocking function).

Still alternatively, the sensing unit may be configured to sense a plurality of users' positions, respectively, and the user's position serving as a detection basis by the detecting unit may be a position of a firstly-sensed user among the plurality of users. That is, a firstly-directed user corresponds to a main user. In this case, data processing for detecting a main user is not required. This may enhance a control speed with respect to the mobile terminal which performs a blocking function.

Still alternatively, the controller provided at the body processes an image corresponding to a sensed user's position among the different images in a different manner from the rest images. For instance, once the sensing unit senses a user's position and the detecting unit detects an image corresponding to the user's position, the controller turns on an image corresponding to the user's position but turns off the rest images. Accordingly, even if a stereoscopic image is implemented in an integral imaging manner, a user may view the stereoscopic image regardless of his or her position. In this case, only one image is displayed on the stereoscopic display unit. This may reduce power consumption of the mobile terminal.

The sensing unit is configured to trace the sensed user's position, and an image corresponding to the user's position may be real-time updated based on a change of the sensed user's position.

Still alternatively, the rest images may be made to emit light more weakly than the corresponding image. Still alternatively, the rest images may be made to have colors different from a color of the corresponding image.

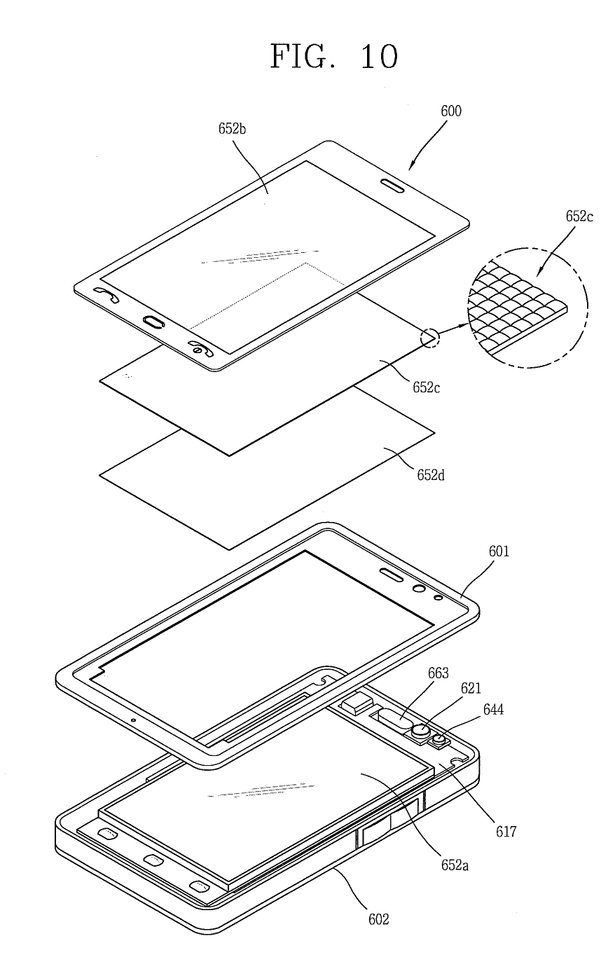

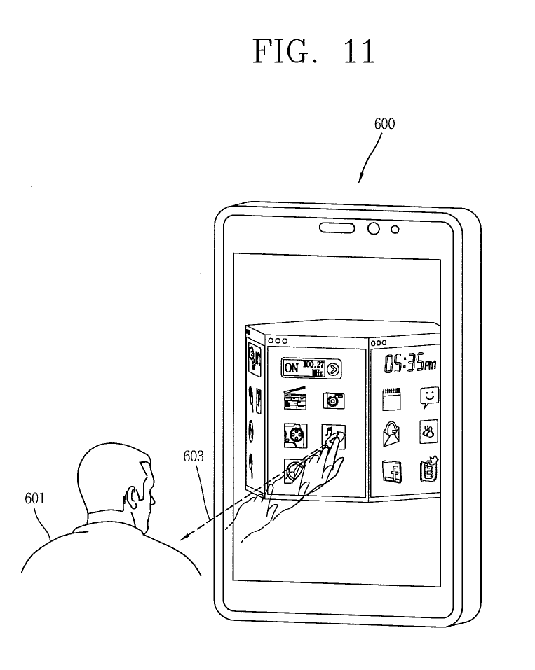

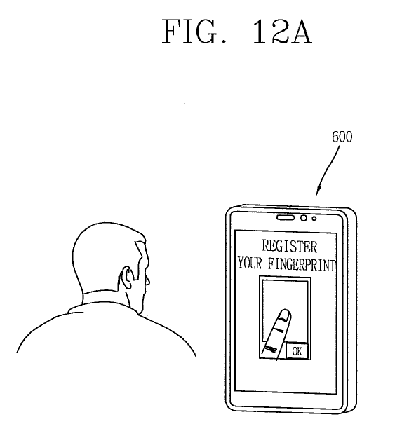

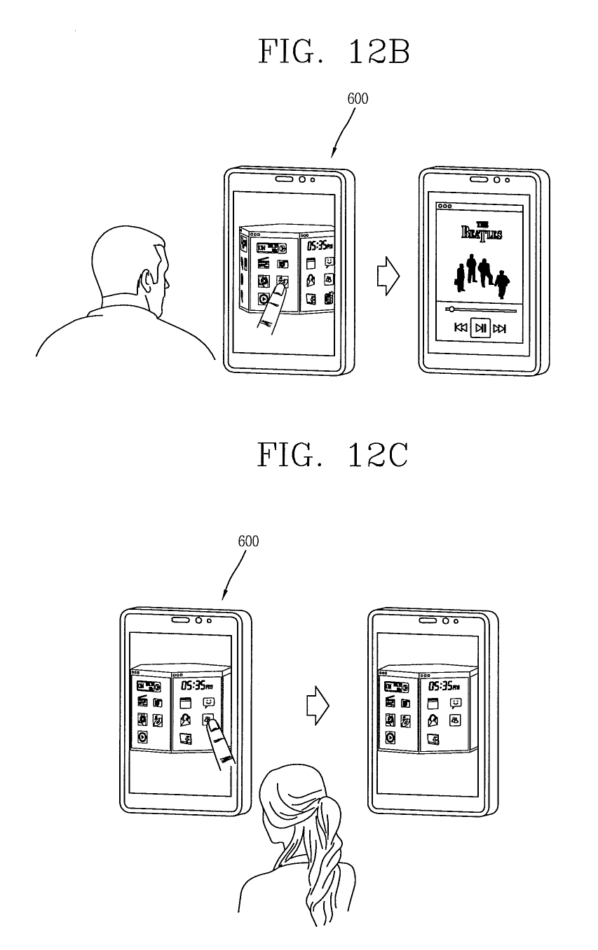

FIG. 10 is an exploded perspective view of a mobile terminal according to another embodiment of the present invention, FIG. 11 is a conceptual view illustrating one embodiment of a touch input implemented by the mobile terminal of FIG. 10, and FIGS. 12A to 12C are conceptual views illustrating another embodiment of a touch input implemented by the mobile terminal of FIG. 10.

Referring to FIG. 10, a photo sensor 652d is laminated on a stereoscopic display unit 652 so that an image of an object which performs a touch input on a stereoscopic image can be captured. More concretely, a lens array 652c and a display 652a are sequentially disposed below a window 652b, and the photo sensor 652d is laminated on the display 652a. The photo sensor 652d is configured to scan a motion of an object approaching to a touch screen.

Under this configuration, a user's position may be estimated only based on a motion of an object which performs a touch input, without detecting the user's position. For instance, for implementation of a stereoscopic image, the stereoscopic display unit 652 displays different images according to a user's viewing angles in an overlaid manner. Then, the sensing unit (photo sensor) senses a motion of an object which performs a touch input on the stereoscopic image. Then, the detecting unit detects, based on the sensed motion, an image corresponding to a touch input by the object among the different images.

Referring to FIG. 11, the sensing unit senses a moving direction of an object to be sensed (a finger in this embodiment). Then, the detecting unit determines that a finger's touch corresponds to a touch input on one of the different images based on the moving direction. That is, when a user 601 is located on an extended line 603 in a moving direction, an image within the range of the user's viewing angle is determined as an image to be touch-input.

A blocking function of the mobile terminal may be implemented by a photo sensor, which will be explained in more details with reference to FIGS. 12A to 12C. FIGS. 12A to 12C are conceptual views illustrating another embodiment (blocking function) of a touch input implemented by the mobile terminal of FIG. 10.

The sensing unit includes a photo sensor laminated on the stereoscopic display unit so as to capture a user's finger which performs a touch input on the stereoscopic display unit. The detecting unit is configured to detect a main user's touch input based on at least one of the finger's moving direction and the user's fingerprint.

For instance, as shown in FIG. 12A, the mobile terminal may execute a mode for receiving a main user's fingerprint. Once a user's finger is disposed on a window, the photo sensor scans the user's fingerprint and the scanned fingerprint is stored in the memory under control of the controller.

As shown in FIG. 12B, once the window is touched by the user's finger, the photo sensor scans the user's fingerprint. If the scanned fingerprint is consistent with a stored fingerprint, the mobile terminal executes a control command corresponding to the touch. However, if the scanned fingerprint is not consistent with the stored fingerprint, the mobile terminal determines that the corresponding user is not a main user and thus does not execute a control command. A blocking function may be executed by using the photo sensor.

In the mobile terminal and the control method thereof according to the present invention, an image corresponding to a touch input is detected among a plurality of different images according to a user's viewing angle, based on a sensed user's position. Also, even if a touch input is executed on the same position of the mobile terminal, an object of the touch input may be detected to execute a different control command.

Furthermore, as only a touch input by a specific user among a plurality of users is sensed, a user customized mobile terminal (e.g., allowing only an input by a main user) may be implemented. Furthermore, in the present invention, an image corresponding to a sensed user's position is processed in a different manner from the rest images. This may provide a new user interface for allowing only a specific user among a plurality of users to view the image. This may reduce power consumption, and the user's privacy may be protected.

The aforementioned method may be implemented as a program code stored in a computer-readable storage medium. The storage medium may include ROM, RAM, CD-ROM, a magnetic tape, a floppy disc, an optical data storage device, etc. And, the storage medium may be implemented as carrier wave (transmission through the Internet). The computer may include the controller of the mobile terminal.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal, comprising:
a body;
a display unit formed at the body, the display unit to display a perceived three-dimensional (3D) image, the 3D image having a plurality of images that are displayed based on a user's different viewing angles;
a sensing unit to sense a user's position with respect to the body; and
a detecting unit to determine, based on the sensed user's position, an image corresponding to a touch input on the perceived 3D image from among the plurality of images.

2. The mobile terminal of claim 1, wherein the sensing unit comprises:
a first sensing portion to sense each of a plurality of user's different positions; and
a second sensing portion to sense a motion of an object that performs the touch input on the perceived 3D image.

3. The mobile terminal of claim 2, wherein the detecting unit determines one of the different positions as a sensing position based on the sensed motion, and the detecting unit determines an image corresponding to the sensed touch input from among the plurality of images based on the sensed user's position.

4. The mobile terminal of claim 3, wherein the sensing position is a position corresponding to a user in a moving direction of the object at a time that the touch input is performed.

5. The mobile terminal of claim 1, wherein the detecting unit to determine whether the touch input corresponds to a touch input by a main user from among a plurality of users.

6. The mobile terminal of claim 5, wherein the sensing unit comprises a camera to capture an image of a user,
wherein the detecting unit to convert a captured image into image data, to determine a preset user's face based on the image data, and to determine the main user's position based on the determined face.

7. The mobile terminal of claim 5, wherein the sensing unit comprises a photo sensor on the display unit to capture a user's finger that performs the touch input on the display unit,
wherein the detecting unit to determine the user's touch input based on the finger's moving direction or the user's fingerprint.

8. The mobile terminal of claim 1, wherein upon sensing the touch input on the perceived 3D image, the plurality of images are converted into images corresponding to the sensed touch input, respectively.

9. The mobile terminal of claim 1, wherein the sensing unit to sense each of a plurality of users' positions, and the detecting unit to determine a main user's position from among the plurality of users' positions.

10. The mobile terminal of claim 9, wherein an image, on the display unit, corresponding to the main user's position from among the different images is activated, while the remaining images on the display unit are deactivated.

11. The mobile terminal of claim 1, wherein the display unit comprises:
a display device mounted to the body;
a lens array to overlap the display device; and
a controller to store the perceived 3D image as a plurality of images, and the controller to display the images on the display device.

12. A mobile terminal, comprising:
a display unit to display a plurality of different images associated with a plurality of viewing angles in an overlaid manner so as to generate a perceived three-dimensional (3D) image;
a sensing unit to sense a motion of an object; and
a detecting unit to determine, based on the sensed motion of the object, an image corresponding to a touch input on the perceived 3D object by the object from among the plurality of different images, wherein the display unit displays the determined image corresponding to the touch input.

13. The mobile terminal of claim 12, wherein the sensing unit to sense a moving direction of the object, and
the detecting unit to determine the touch input on one of the plurality of different images based on the sensed moving direction.

14. The mobile terminal of claim 12, wherein the sensing unit comprises:
a first sensing portion to sense each of a plurality of user's different positions; and
a second sensing portion to sense the motion of the object that performs the touch input on the perceived 3D image.

15. The mobile terminal of claim 14, wherein the detecting unit determines one of the different positions as a sensing position based on the motion, and the detecting unit determines an image corresponding to the touch input from among the different images based on the sensed user's position.

16. The mobile terminal of claim 12, wherein the sensing unit comprises a camera to capture an image of a user,
wherein the detecting unit to convert a captured image into image data, to determine a preset user's face based on the image data, and to determine the user's position based on the determined face.

17. The mobile terminal of claim 12, wherein the sensing unit comprises a photo sensor on the display unit to capture a user's finger that performs the touch input on the display unit,
wherein the detecting unit to determine the user's touch input based on the finger's moving direction or the user's fingerprint.

18. The mobile terminal of claim 12, wherein the sensing unit to sense each of a plurality of users' positions, and the detecting unit to determine a main user's position from among the plurality of users' positions.

19. The mobile terminal of claim 12, wherein an image, on the display unit, corresponding to the main user's position from among the different images is activated, while the remaining images on the display unit are deactivated.

20. The mobile terminal of claim 12, wherein the display unit comprises:
a display device mounted to the body;
a lens array to overlap the display device; and
a controller to store the perceived 3D image as a plurality of images, and the controller to display the images on the display device.

21. A method for controlling a mobile terminal, the method comprising:
displaying, on a display, a perceived three-dimensional (3D) image having a plurality of different images based on different viewing angles;
sensing a user's position with respect to a body of the mobile terminal;
sensing a touch input on the displayed perceived 3D image; and
determining, based on the sensed user's position, an image corresponding to the sensed touch input from among the plurality of different images.

22. The method of claim 21, wherein sensing the user's position includes sensing a plurality of user's positions,
wherein sensing the touch input includes sensing a position of an object to perform the touch input on the image, and
wherein determining the image includes setting one of the plurality of users' positions as a user's position corresponding to the touch input based on a position change of the object.

23. The method of claim 21, wherein detecting the image includes determining whether the touch input corresponds to a touch input by a main user from among a plurality of different users.

24. The method of claim 21, further comprising sensing each of a plurality of users' positions, and determining a main user's position from among the plurality of users' positions.

25. The method of claim 23, further comprising displaying the determined image corresponding to the sensed touch input.
